(19) United States
(12) Patent Application Publication
(10) Pub. No.: US 2002/0042727 A1
(43) Pub. Date: Apr. 11, 2002

(54) Compensation-granting system and method and server thereof

(76) Inventors: Takafumi Soramoto, Tokyo (JP); Yukihiro Sawa, Tokyo (JP); Taihei Mimura, Tokyo (JP); Osamu Konishi, Tokyo (JP)

Correspondence Address: PILLSBURY WINTHROP LLP, 1600 TYSONS BOULEVARD, MCLEAN, VA, 22102, US

(21) Appl. No.: 09/824,877

(22) Filed: Apr. 4, 2001

(30) Foreign Application Priority Data
Oct. 5, 2000 (JP) 2000-306733

(51) Int. Cl. G06F 17/60

(52) U.S. Cl. 705/4

(57) ABSTRACT

A server provides compensation, such as insurance, to a user who purchases merchandise by electronic commerce. The server provides a compensation granting portal site having a first URL on the Internet. The server includes a URL rewriting unit for receiving a second URL of a web page of another server upon a user's request, and rewriting the second URL to be linked to the first URL and transmitting the rewritten second URL to the user.

This patent application claims priority from a Japanese patent application No. 2000306733, filed on Oct. 5, 2000, the contents of which are incorporated herein by reference.

### BACKGROUND OF THE INVENTION

1. Field of the Invention

The present invention relates to a server, a compensation-granting system, and a method for granting compensation. More particularly, the present invention relates to granting compensation, such as by an insurance service, for merchandise purchased on the Internet.

2. Description of the Related Art

With development of the Internet, selling merchandise using the Internet (i.e., electronic commerce) has become widely practiced. In a typical electronic commerce transaction, a user accesses a web page that sells merchandise electronically. Next, the user inputs necessary data sequentially to purchase merchandise in a merchandise-purchase screen. Necessary data to be input may include a name, an address, identification of the merchandise, a price, and a settlement means. If the user is approved to purchase the merchandise, the merchandise is sent to the predetermined address, and the account is settled using electronic money, for example.

However, in electronic commerce, there is the possibility that an accident or other problem could occur such that the purchased merchandise is not delivered to the user, or merchandise, which is different from the purchased merchandise, is delivered to the user, or the merchandise delivered to the user is damaged when it arrives. At present, only limited means, such as using a specific credit card or exchanging the merchandise at a specific web site, are available to insure against an accident or problem of the type explained above. A user cannot easily be provided with insurance for electronic commerce transactions so that a user does not feel assured about safe delivery of merchandise purchased by electronic commerce until the merchandise is actually delivered to the user.

### SUMMARY OF THE INVENTION

Therefore, it is one object of the present invention to provide a portal site server, which is capable of overcoming the above drawbacks. This and other objects can be achieved by combinations described in the independent claims. The dependent claims define further advantageous and exemplary combinations of the present invention.

According to a first aspect of the present invention, a server is provided for a compensation-granting portal site having a first URL on the Internet. The sever comprises a URL rewriting unit for receiving a second URL of a web page of another server upon a user's request, and for rewriting the second URL to be linked to the first URL and for transmitting the rewritten second URL to the user.

The server may further comprise a compensation-granting unit connected to the URL rewriting unit, the granting unit granting compensation relating to a deal or transaction performed by a user on the web page having the second URL. The compensation-granting unit may grant the compensation by means of an insurance.

The server may further comprise a compensation-granting database for storing identification information that identifies the web page having the second URL, which provides the deal for which the compensation can be granted. The URL rewriting unit rewrites the second URL when identification information of the web page requested by the user is stored in the compensation-granting database.

The server may further comprise a compensation-granting database for storing identification information that identifies the web page having the second URL, which provides the deal for which the compensation can be granted. The compensation-granting database grants compensation for the deal when identification information of the web page, on which the deal is performed, is stored in the compensation-granting database.

The server may further comprise a compensation-granting database for storing identification information that identifies the web page having the second URL, which provides the deal for which the compensation can be granted. An indicating unit is provided for indicating on a terminal of a user that compensation is granted for the deal performed on the web page when identification information of a web page requested by the user is stored in the compensation-granting database.

The server may further comprise a history database for storing an access history of a user accessing a web page having the first URL with corresponding identification information of the user. A compensation-executing unit is provided for judging whether the deal is truly performed, when the user applies for compensation for the deal, using the access history stored in the history database, and for paying the compensation to the user when the deal is truly performed.

The server may further comprise a history database for storing an access history of a user accessing a web page having the first URL with corresponding identification information of the user. The access history is used by the compensation-granting unit to judge whether to grant the compensation to the user based on a time of final access to the first URL.

The server may further comprise a storing unit for storing the information that specifies a time of final access to a web page having the first URL by a user. The compensation-granting unit judges whether to grant the compensation to the user based on the time of final access stored in the storing unit.

According to a second aspect of the present invention, a compensation-granting system on the Internet is provided. The compensation-granting system comprise: a portal site server having a first URL and a user terminal through which a user requests a second URL; the portal site server is connected to the user terminal through the Internet. The system includes a URL rewriting unit for receiving the second URL of a web page of another server upon a user's request, and for rewriting the second URL to be linked to the first URL and for transmitting the rewritten second URL to the user.

The compensation-granting system may further comprise a compensation-granting unit connected to the URL rewriting unit. The compensation-granting unit granting compensation relating to a deal or transaction performed by a user on the web page having the second URL.

According to a third aspect of the present invention, a method for granting compensation for a deal or transaction performed on the Internet is provided. The method comprises the step of receiving a web page server URL upon a user's request; the step of rewriting the web page URL to be linked to a portal site server URL which grants compensation for a deal; and the step of transmitting the rewritten web page server URL to the user.

The method may further comprise the step of granting compensation for the deal or transaction that is performed by the user on the web page having the web page server URL. The step of granting compensation may grant the compensation by means of an insurance.

The method may further comprise the step of storing identification information that identifies a web page having the web page server URL which provides the deal, to which the compensation can be provided. The step of rewriting the web page server URL rewrites the web page server URL when identification information of a web page requested by the user is stored by the storing step.

The method may further comprise the step of storing identification information that identifies a web page which provides a deal, to which the compensation can be provided. The step of granting the compensation grants compensation to the deal when identification information of a web page, on which the deal is performed, is stored by the storing step.

The method may further comprise the step of storing identification information that identifies a web page which provides a deal, to which the compensation can be provided; and the step of indicating on a terminal of the user that the compensation is granted to the deal performed on the web page when the identification information of the web page requested by the user is stored by the storing step.

The method may further comprise the step of storing an access history of the user accessing the portal site server with corresponding identification information of the user. The step of judging whether the deal is truly performed is based on the access history stored by the storing step when the user applies for compensation for the deal; and the step of paying the compensation to the user when the deal is truly performed.

The method may further comprise the step of storing an access history of the user accessing the portal site server with corresponding identification information of the user; and the step of judging whether to grant the compensation to the user based on a time of final access to the portal site server using the access history.

The method may further comprise the step of storing information that specifies a time of final access to the portal site server by the user; and the step of judging whether to grant compensation to the user based on the time of final access to the portal site server using the information.

According to a fourth aspect of the present invention, a method for granting compensation for a deal or transaction performed on the Internet is provided. The method comprises the step of receiving access of a user who performs a deal at a web page linked to a portal site server that grants compensation; and the step of granting a compensation for the deal performed by the user. The step of granting the compensation may grant the compensation by means of an insurance.

The method may further comprise the step of storing a total amount of sales of merchandise sold at the web page and a total amount of the insurance paid to the user, which is granted for the merchandise, with corresponding merchandise identification information that identifies the merchandise; and the step of setting or updating an amount of the insurance for the merchandise according to a ratio of the total amount of the insurance to the total amount of sales.

The method may further comprise the step of storing a total amount of sales of merchandise sold at web pages operated by member stores and a number of times of granting the insurance to merchandise sold by each member store with corresponding member store identification information that identifies the member store; and the step of setting or updating a premium paid by the member store according to a ratio of the number of times of granting the insurance to the total amount of sales.

The step of setting or updating may set or update an amount of compensation that can be paid to the user according to the ratio of the number of times of granting the insurance to the total amount of sales.

The method may further comprise the step of storing a total amount of sales of merchandise sold at web pages operated by member stores and an amount of the insurance paid to the user for merchandise sold by each member store with corresponding member store identification information that identifies the member store; and the step of setting or updating a premium paid by the member store according to a ratio of the amount of the insurance paid to the user to the total amount of sales.

The step of setting or updating may set or update an amount of compensation that can be paid to the user according to the ratio of the amount of insurance paid to the user to the total amount of sales.

The method may further comprise the step of storing a total amount of purchase of the user purchased at the web page and a number of times of applying for the insurance by the user with corresponding user identification information that identifies the user; and the step of setting or updating an amount of compensation that can be paid to the user according to a ratio of the number of times of applying for the insurance by the user to the total amount of purchase of the user.

The step of setting or updating may set or update an amount of compensation that can be paid to the user according to the ratio of the number of times of applying for the insurance by the user to the total amount of purchase of the user.

The method may further comprise the step of storing a total amount of purchase of the user purchased at the web page and an amount of compensation paid to the user with corresponding user identification information that identifies the user; and the step of setting or updating an amount of compensation that can be paid to the user according to a ratio of the amount of compensation paid to the user to the total amount of purchase of the user.

The step of setting or updating may set or update the amount of compensation that can be paid to the user according to the ratio of the amount of compensation paid to the user to the total amount of purchase of the user. The step of setting or updating may set or update a limit of compensation that can be applied to the merchandise according to the ratio of the number of times of applying for the insurance by the user to the total amount of purchase of the user.

The step of setting or updating may set or update a limit of compensation that can be applied to the merchandise according to the ratio of the amount of compensation paid to the user to the total amount of purchase of the user. The step of setting or updating may set or update a limit for the user to purchase merchandise, for which the compensation can be paid, according to the ratio of the number of times of applying for the insurance by the user to the total amount of purchase. The setting or updating may set or update a limit for the user to purchase merchandise, for which the compensation can be paid, according to the ratio of the amount of compensation paid to the user to the total amount of purchase of the user.

The method may further comprise the step of storing a number of times of access to the portal site server by the user; and the step of judging whether to provide the compensation to the user based on the number of times of access.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a configuration of a system that includes an insurance-providing portal site server 10 of a first embodiment of the present invention.

FIG. 2 shows a configuration of the insurance-providing portal site server 10 of a first embodiment.

FIG. 3 shows a configuration of a user terminal 20. The user terminal 20 has a process unit 40.

FIG. 4 shows an example of a user database 12.

FIG. 5 shows an example of a member store database 14.

FIG. 6 shows an example of a deal database 16.

FIG. 7 shows an example of an objected or rejected merchandise database 18.

FIG. 8 shows a screen 50 of a member store web page.

FIG. 9 shows a flow chart of the process of applying for insurance in a first embodiment.

FIG. 10 shows a flow chart of a process when a user accesses the insurance-providing portal site server 10 (S100).

FIG. 11 shows a flow chart of a process of purchasing merchandise and applying for insurance (S120).

FIG. 12 shows a flow chart of a process for applying for the insurance by a user and application of insurance (S130).

FIG. 13 shows a system including a portal site server 100 of a second embodiment of the present invention.

FIG. 14 shows the hardware configuration of the portal site server 100 of a second embodiment.

FIG. 15 shows an example of a compensation-granting database 90.

FIG. 16 shows an example of a history database 92.

FIG. 17 shows another example of a history database.

FIG. 18 shows the configuration of the portal site server 100.

FIG. 19 shows an example when a rewriting unit rewrites the link information of a member store web page.

FIG. 20 shows a flow chart of a compensation applying process of a second embodiment.

FIG. 21 shows an example of a process related to the request for a web page and rewriting of the web page link (S410).

FIG. 22 shows an example of a process related to granting compensation (S420).

FIG. 23 shows another example of a process related to granting compensation (S420).

FIG. 24 shows a flow chart of a process related to application for compensation and payment of the compensation (S430).

### DETAILED DESCRIPTION OF THE INVENTION

The invention will now be described based on preferred embodiments, which is not intended to limit the scope of the present invention, but to exemplify the invention. All of the features and the combinations thereof described in the embodiment are not necessarily essential to the invention.

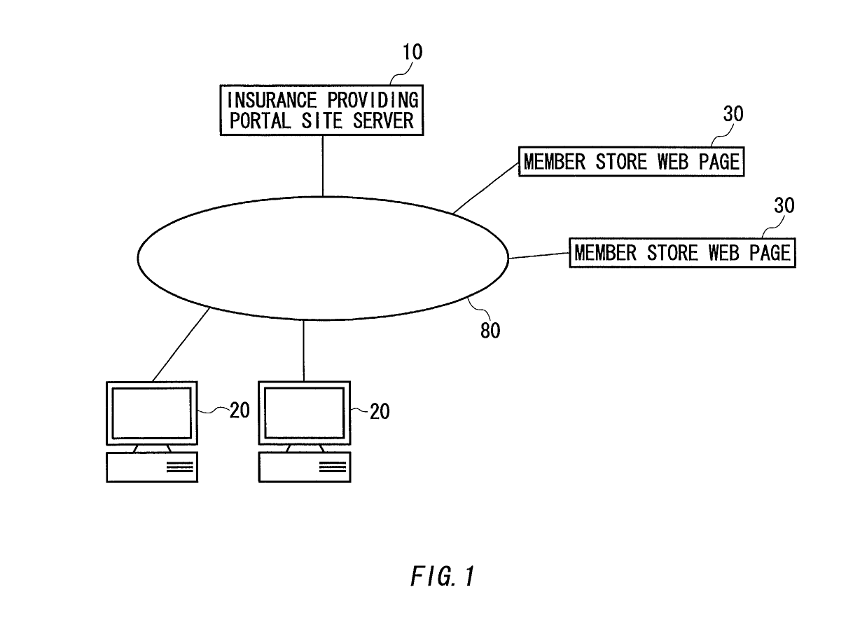

FIG. 1 shows a configuration of a system that includes an insurance-providing portal site server 10 of a first embodiment of the present invention. The insurance-providing portal site server 10 is an example of a server for a compensation-granting portal site. The insurance-providing portal site server 10 is connected to the Internet 80. The insurance-providing portal site server 10 provides the insurance-providing portal site that transmits information related to insurance through the Internet 80. An insurance company, for example, operates the insurance-providing portal site server 10. A member store, which is a member of this system, provides a member store web page 30.

The member store web page 30 can also be accessed through the Internet 80. A user terminal 20 used by a user is connected to the Internet 80. The user performs a deal (i.e., electronic commerce) such as purchasing merchandise at the member store web page 30. The user can get access to the insurance-providing portal site and the member store web page 30 from the user terminal 20. The insurance-providing portal site server 10 provides the insurance-providing portal site. The member store provides the member store web page 30.

The user accesses the insurance-providing portal site server 10 to purchase merchandise. The insurance-providing portal site server 10 authenticates a user who accesses the insurance-providing portal site server 10. If the user is authenticated by the insurance-providing portal site server 10, the user gets access to the member store web page 30. The user inputs necessary data on a merchandise-purchase screen to purchase merchandise. Then, insurance is granted for purchasing the merchandise on the member store web page 30. Thereafter, insurance payment can be made to the user when an accident or trouble occurs, such as merchandise purchased by the user is not sent to the user, or merchandise, which is different from the merchandise purchased by the user, is sent to the user, or the merchandise sent to the user is broken or damaged during shipping.

The member store pays basic premium to insure merchandise sold at the member store when the member store becomes a member of this system. Thereby, the user does not have to pay the premium to be provided the insurance. Furthermore, the user can select additional insurance at a premium according to his needs.

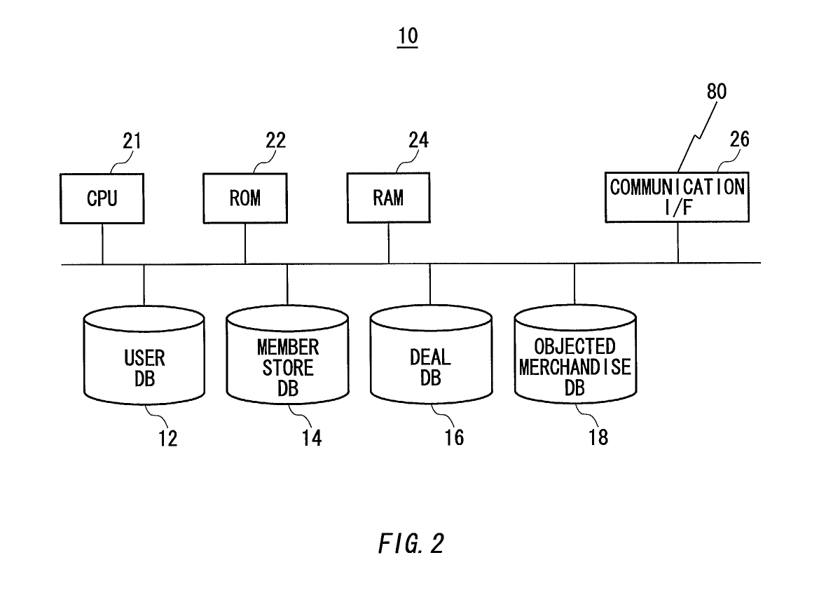

FIG. 2 shows a configuration of the insurance-providing portal site server 10 of a first embodiment. The insurance-providing portal site server 10 has a CPU 21, a ROM 22, a RAM 24, a communication interface 26, a user database 12, a member store database 14, a deal database 16, and an objected or rejected merchandise database 18.

The insurance-providing portal site server 10 processes the user database 12, the member store database 14, the deal database 16, and the objected merchandise database 18 according to a program stored in the CPU 21, the ROM 22, and the RAM 24. Then, the insurance-providing portal site server 10 transmits the processed results to the Internet 80 through the communication interface 26.

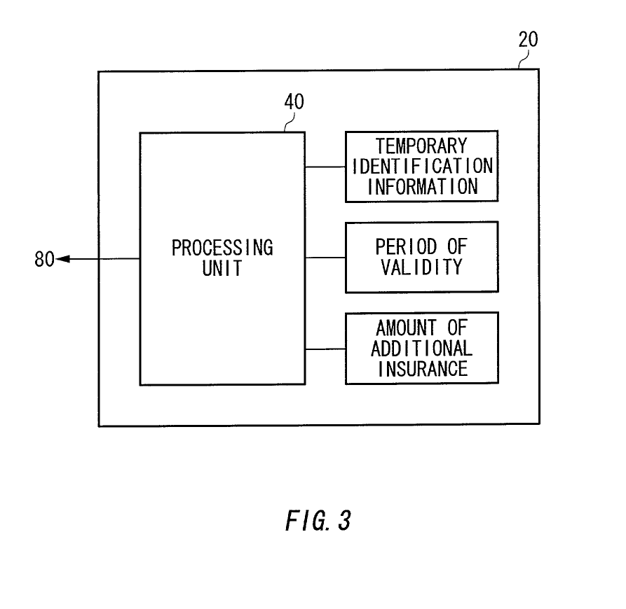

FIG. 3 shows a configuration of the user terminal 20. The user terminal 20 has a processing unit 40. The processing unit 40 transmits information, which is input from an input apparatus such as a mouse and a keyboard by the user, to the Internet 80. The processing unit 40 also displays information, which is sent from the insurance-providing portal site server 10 and the member store web page 30, on a monitor screen. The processing unit 40 also writes the obtained information to a recording medium such as a hard disk. The processing unit 40 also reads the obtained information, which is written into the hard disk. The obtained information includes temporary identification information, a period of validity, and an amount of additional insurance.

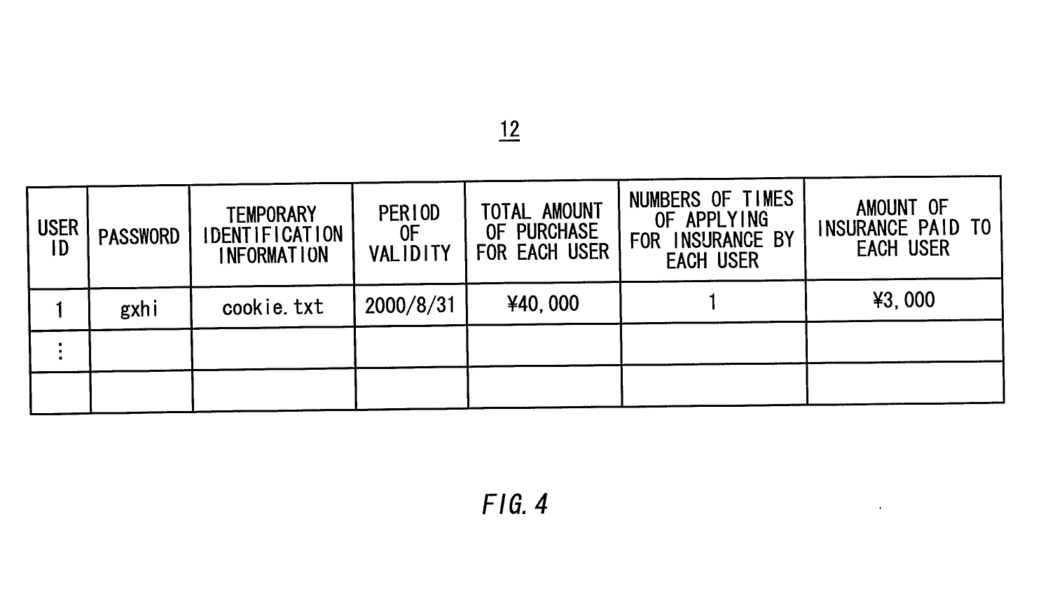

FIG. 4 shows an example of the user database 12. Information of a password, temporary identification information, period of validity, total amount of purchase for each user, numbers of times of applying for insurance by each user, and an amount of insurance paid to each user is stored in the user database 12 to correspond with the user ID (user identification information) that identifies the user.

The password is used to authenticate the user when the user accesses the insurance-providing portal site server 10. The temporary identification information is, for example, a cookie written into the user terminal 20. Here, the cookie may be encrypted by a method so that the cookie cannot be decrypted by a user and can be decrypted only by the member store server, for example. The cookie includes information such as information of the user, information of the web page accessed by the user, and information of the data and the time when the user accesses the web page.

Furthermore, another example of the temporary identification information is information of the date and the time of a final or last access by the user to the insurance-providing portal site server 10. This is the time when the user accesses the member store web page 30 through the insurance-providing portal site server 10. In this case, the insurance-providing portal site server 10 judges whether to provide compensation to the user based on whether the time for purchasing the merchandise or the time for applying for insurance has elapsed based upon a predetermined period from the time of final access of the temporary identification information.

The period of validity defines the period during which the temporary identification information is considered to be valid. The total amount of purchase for each user is a total amount of the deals or transactions performed by the user and which are insured by the insurance-providing portal site. The numbers of the times of applying for insurance by each user shows how many times the user applies for insurance for the deals. The amount of insurance paid to each user shows the amount of insurance actually paid to the user.

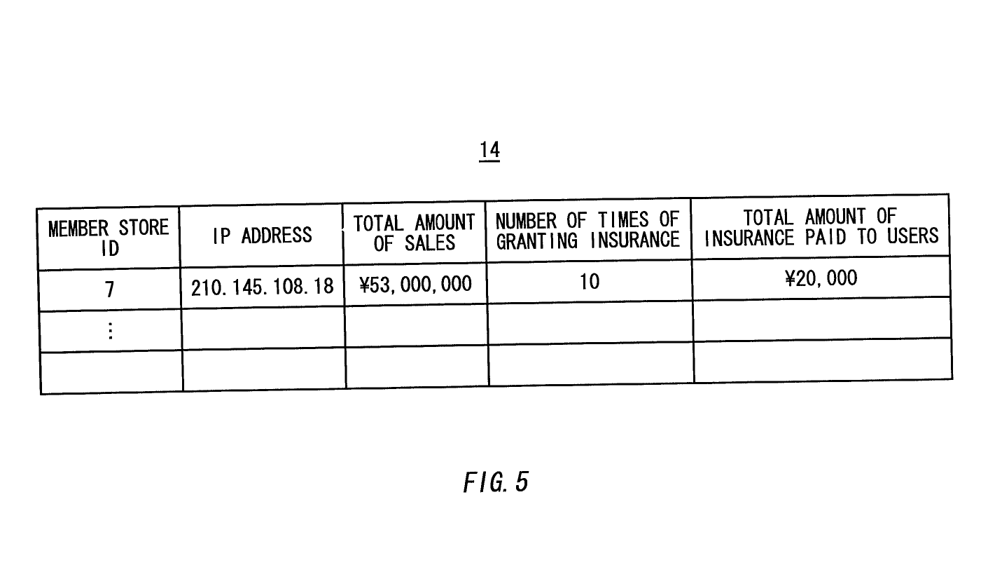

FIG. 5 shows an example of the member store database 14. An IP address, a total amount of sales, a number of times of granting insurance, a total amount of insurance paid to the user are stored in the member store database 14 with the corresponding member store ID (member store identification information) that identifies the member store. The IP address is an identification number assigned to each member store connected to the Internet. A numerical value of 32 bits, which is divided into four parts by 8 bits, is used for the IP address. The IP address is thus expressed as such as “210.145.108.18”.

The total amount of sales is a total amount of deals or transactions performed by the member store while the insurance is provided by the insurance-providing portal site. The number of times of granting insurance is the number of times that insurance is granted to deals of the member store. The amount of insurance paid to the user is the total amount of insurance paid to users by applying insurance for the deals.

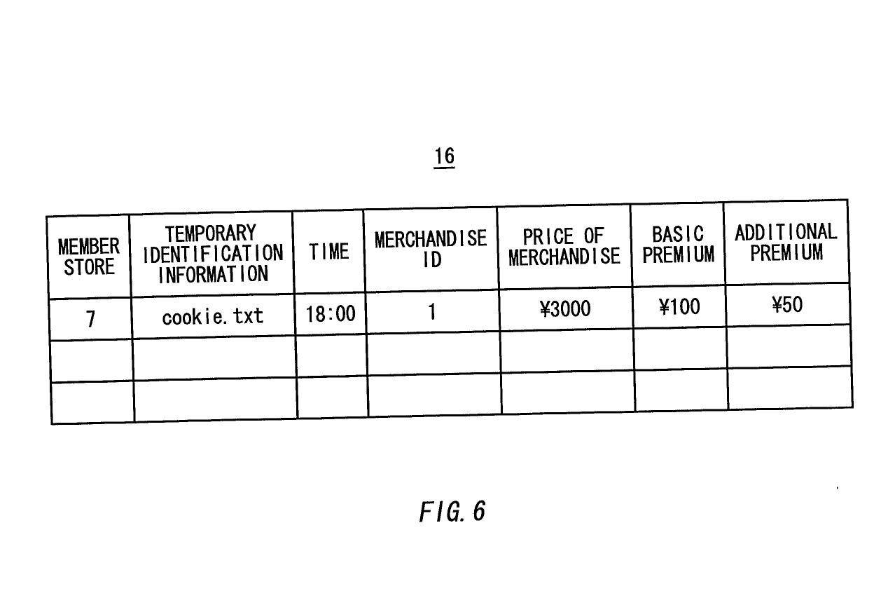

FIG. 6 shows an example of the deal database 16. Temporary identification information, time, merchandise ID, price of merchandise, a basic premium, and an additional premium are stored in the deal database 16 with the corresponding member store ID that identifies the member store. The deal database 16 is updated every time when a deal is concluded in the member store web page 30. The time shows the time when a deal is concluded in the member store web page 30.

The merchandise ID is information to identify the merchandise which is sold at the member store web page 30. The same merchandise ID is used for identical merchandise even if the member store web pages 30 that sell the identical merchandise are different. The price of the merchandise shows the price of the merchandise. The basic premium is a basic amount of the premium necessary for insuring the merchandise. The additional premium is the amount of premium added to the basic premium. The user can increase the amount of insurance paid to the user by paying the additional premium.

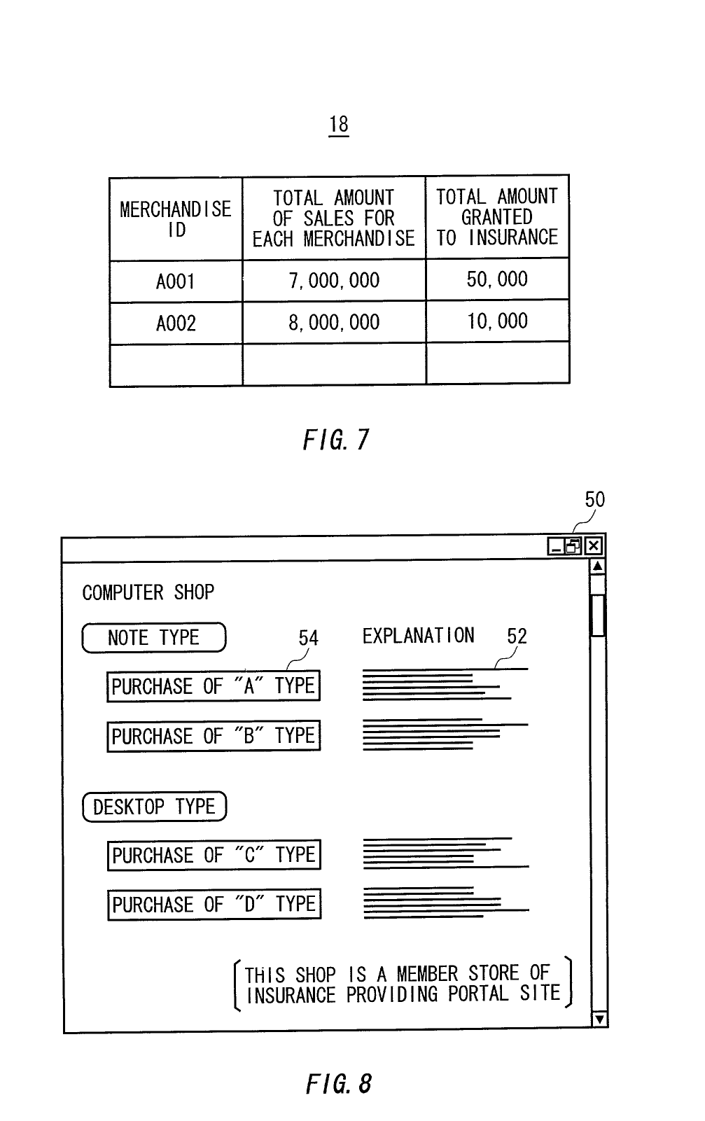

FIG. 7 shows an example of the objected-merchandise database 18. A total amount of the sales for each merchandise and a total amount granted as insurance are stored in the objected-merchandise database 18 with the corresponding merchandise ID that identifies the merchandise. The total amount of sales for each merchandise is a total amount of insured merchandise sold to the user. The total amount granted as insurance is a total amount of insurance claims paid to the user by applying the insurance to each of the objected or rejected merchandise sold at the plurality of the member store web pages 30.

FIG. 8 shows a screen 50 of the member store web page 30. Computers are sold in the member store web page 30 in this example. The member store web page 30 has an explanation 52 for each merchandise to provide information related to the merchandise to the user. The member store web page 30 also has a purchasing button 54 for purchasing each of the merchandise to enable the user to purchase the merchandise. If the purchasing button is clicked, the user is requested to input information such as attribute information including name and address of the user, merchandise information such as the name and price of the merchandise to be purchased, and information related to the method of settlement.

In the following, the process of settlement and changing of a premium for an amount of insurance realized by the insurance-providing portal site server 10 will be described.

Setting or Updating of Premium:

The premium for the insured merchandise is set or updated according to the total amount of the sales for each merchandise and the total amount granted as insurance stored in the objected merchandise database 18. Specifically, the premium for insuring specific merchandise increases as the ratio of the total amount granted as insurance to the total amount of sales of the specific merchandise increases. Because the total amount of sales for each item of merchandise and the total amount granted as insurance reflects the results of the merchandise deals at the plurality of member stores, it is possible to set the premium according to the risk or reliability for each deal of the merchandise.

Furthermore, the premium for insuring the merchandise is set or updated according to the total amount of sales, the number of times of granting insurance, and the amount of insurance paid to the user stored in the member store database 14. Specifically, the premium is set or updated according to at least one of the ratio of the number of times of granting insurance coverage to the total amount of sales, or the ratio of the amount of insurance paid to the user to the total amount of sales. More specifically, the premium increases with an increase of the ratio of the number of times of granting insurance to the total amount of sales, or the ratio of the amount of insurance paid to the user to the total amount of sales. Thereby, it is possible to set the premium according to the risk or the reliability of the member store.

Setting or Updating of Amount of Insurance:

The insurance paid to the user is set or updated according to the total amount of the purchase for each user, the number of times of applying for insurance by each user, and the amount of insurance paid to each user stored in the user database 12. Specifically, the amount of insurance paid is set or updated according to at least one of the ratio of the number of times of applying for the insurance by each user to the total amount of purchase for each user, or the ratio of the amount of insurance paid to each user to the total amount of purchase for each user.

More specifically, the amount of insurance to be paid to users decreases with the increase of the ratio of the number of times of applying for the insurance by each user to the total amount of purchase for each user, or the ratio of the amount of insurance paid to each user to the total amount of purchase for each user. Thereby, it is possible to set the amount of insurance according to the risk or the reliability of the user.

Furthermore, the amount of insurance to be paid to the user may be set or updated according to at least one of the ratio of the number of times of granting the insurance or the amount of insurance paid to the user to the total amount of purchase using the member store database 14 and the user database 12.

Furthermore, the amount of insurance to be paid to the user may also be set or updated according to at least one of the ratio of the number of times of applying for the insurance by each user or the amount of insurance paid to each user to the total amount of purchase for each user using the member store database 14 and the user database 12.

For example, a case is considered when the ratio of the amount of the insurance paid to a specific user to the total amount of the purchase by the specific user is low. Furthermore, the ratio of the amount of insurance paid to the specific user to the total amount of sales of the member store web page 30 is low. Then, if the user described above purchases merchandise at the member store web page 30 described above, the amount of insurance for the merchandise, which is to be purchased by the user, will increase. Thereby, it is possible to set the amount of insurance according to the risk or the reliability of the member store and the user.

Setting or Updating of Coverage for Each Merchandise:

The coverage of the insurance that can be paid to the user for each purchased merchandise is set or updated according to the total amount of sales for each merchandise and the total amount of claimed insurance paid for each merchandise stored in the rejected merchandise database 18. Specifically, the coverage of insurance is set or updated so that the coverage of insurance increases with the decrease of the ratio of the total amount paid for claimed insurance for each merchandise to the total amount of sales for each merchandise.

Expensive insurance can be provided for merchandise if the total amount of sales of the merchandise increases and also the total amount paid to the claimed insurance for each merchandise decreases. On the other hand, the insurance company does not have to provide expensive or high insurance for merchandise which does not have information about the reliability.

Setting or Updating of the Limit Amount of Purchasing the Insured Merchandise:

The limit amount of insurance for the user to purchase the insured merchandise is set or updated according to the total amount of the purchase for each user, the number of times of applying for the insurance for each user, and the amount of insurance paid to each user stored in the user database 12. Specifically, the limit amount of purchase is set or updated so that the limit amount of purchase increases with the decrease of the ratio of the number of times of applying for the insurance by each user or the amount of insurance paid to each user to the total amount of purchase for each user.

Expensive or high insurance can be provided to a user if the user increases the purchase of merchandise at the member store web page 30 and also does so without applying for the insurance. On the other hand, the insurance company does not have to provide expensive or high insurance to a user for whom there is no information about reliability.

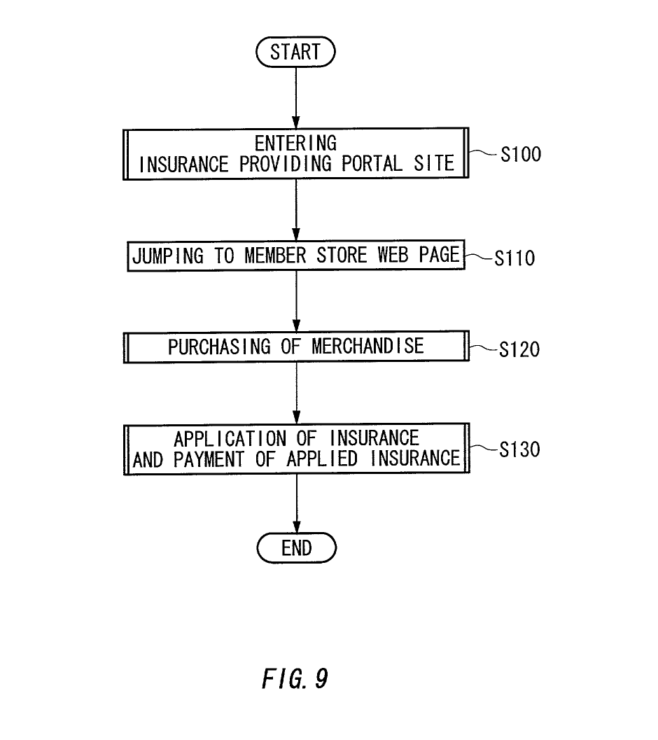

FIG. 9 shows a flow chart of a process for applying for the insurance of a first embodiment. First, the user enters the insurance-providing portal site (S100). The insurance-providing portal site server 10 indicates or provides to the user a link to the member store web page 30 by an inside logic function such as CGI.

If the user jumps to the member store web page 30, the insurance-providing portal site server 10 provides the URL of the insurance-providing portal site as a parameter linked to the member store server (S110). The member store server provides the member store web page 30.

The user purchases merchandise at the member store web page 30 (S120). The user applies for insurance to cover an accident such that if the purchased merchandise is not sent to the user by a predetermined date, or the purchased merchandise is broken. The insurance-providing portal site server 10 processes the insurance applied for by the user (S130).

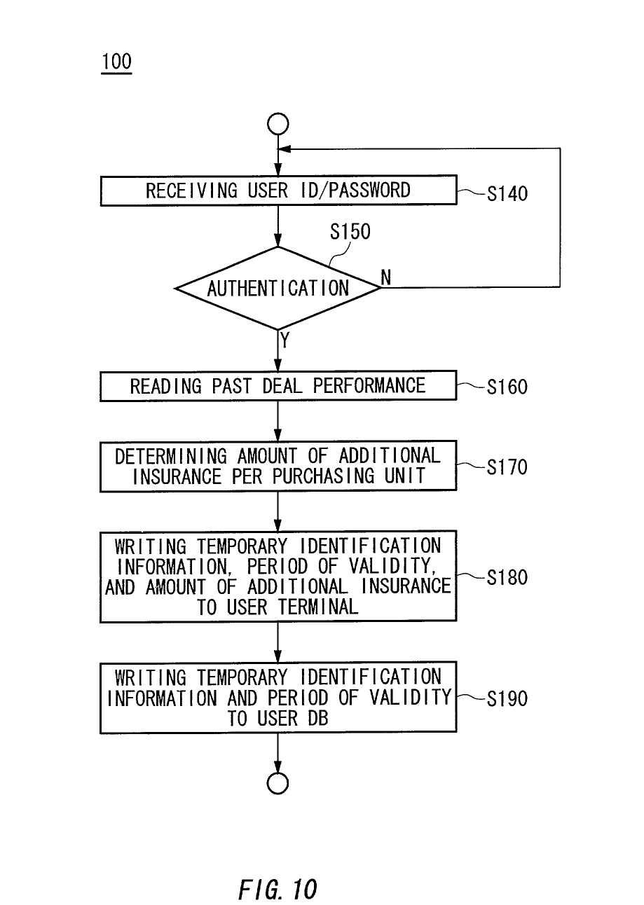

FIG. 10 shows a flow chart that shows a process when the user accesses the insurance-providing portal site server 10 (S100). The insurance-providing portal site server 10 receives a user ID and a password from the user terminal 20 (S140). Then, the insurance-providing portal site server 10 judges whether the user ID and password are stored in the user database 12 (S150).

If the user ID and password are not stored in the user database 12, the process advances to N, and the receipt of the user ID and the password is performed again. If the user ID and password are stored in the user database 12, the process advances to Y, and the results of the past deals of the user are read from the user database 12 according to the user ID (S160).

Next, additional premium per purchasing unit price is determined (S170). The temporary identification information, the period of validity, and the additional premium are written into the user terminal 20 (S180). Finally, the temporary identification information and the period of validity are written into the user database 12 (S190).

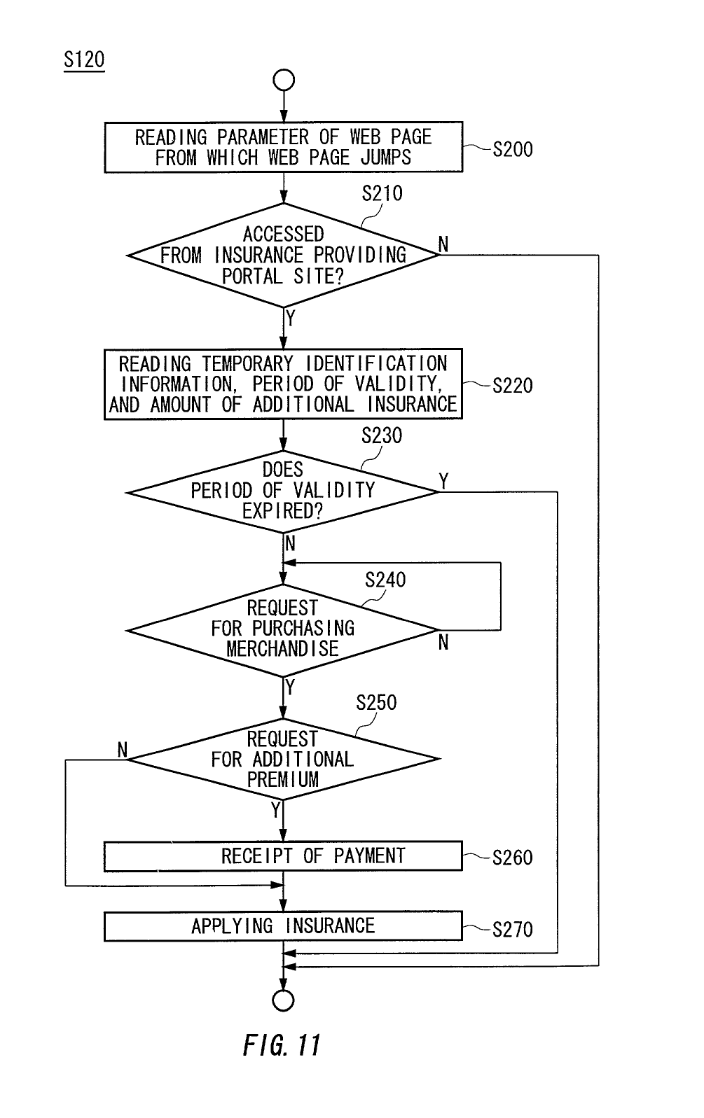

FIG. 11 shows a flow chart that shows the process for purchasing the merchandise and applying for the insurance by the user (S120). The member store server reads the parameter that shows the URL from which the user jumps (S200).

As a specific example, the member store server reads the parameter that shows the web page from which the user jumps by reading the cookie that is stored in the user terminal 20. Then, the member store server judges whether the web page from which the user jumps is the insurance-providing portal site (S210).

If the web page from which the user jumps is not the insurance-providing portal site, the process of purchasing the merchandise and applying for the insurance is finished. If the web page from which the user jumps is the insurance-providing portal site, the temporary identification information, the period of validity, and the additional premium are read from the user terminal 20 (S220). Then, whether the period of validity has already elapsed is judged (S230).

If the period of validity has already elapsed, the process of purchasing the merchandise and applying for the insurance is finished. If the period of validity has not elapsed, purchase of the merchandise is requested to the user, and the result selected by the user is received (S240). If the user purchases the merchandise, the additional premium is requested (S250). If the user accepts the request of additional premium, the payment of the additional premium is processed (S260). The member store server applies for the insurance from the insurance-providing portal site server 10 (S270).

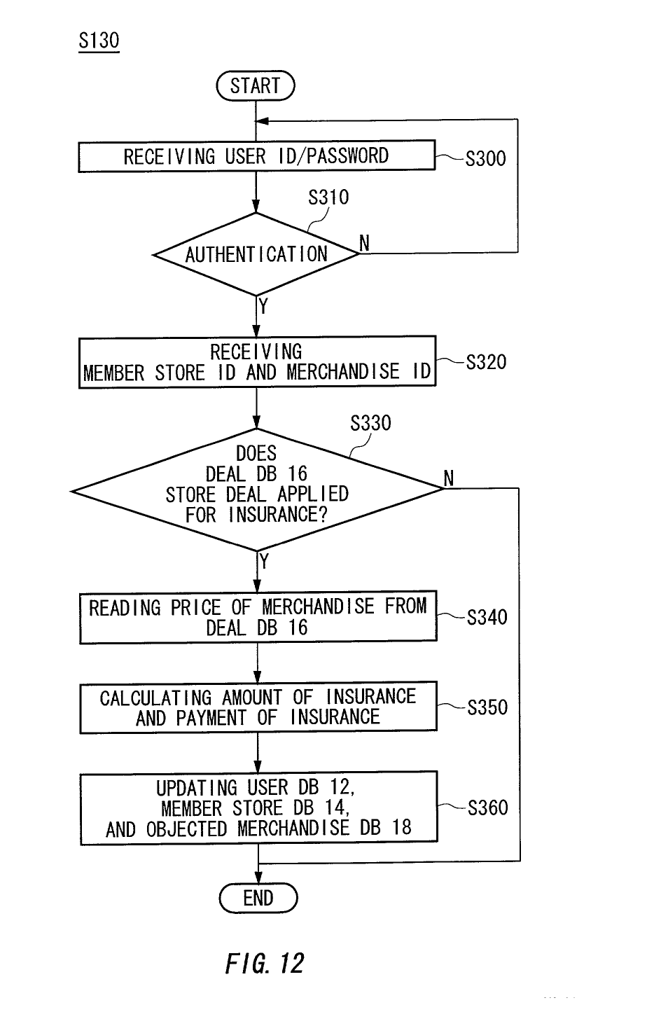

FIG. 12 shows a flow chart of a process for insurance claim by the user and the process of using the insurance (S130). The insurance-providing portal site server 10 receives the user ID and the password from the user (S300). Then, it is judged whether the user ID and the password are stored in the user database 12 (S310).

If the user ID and password are not stored in the user database 12, the user ID and password are received again from the user. If the user ID and password are stored in the user database 12, the user is authenticated. Next, the member store ID and the merchandise ID, which are related to the deal for which insurance payment is requested, are received (S320). Then, whether the deal for which insurance payment is requested is stored in the deal database 16 is investigated (S330).

If the deal for which insurance is claimed is not stored in the deal database 16, the process for claiming insurance by the user and the process of using the insurance is finished. If the deal is stored in the deal database 16, the price of the merchandise is read from the deal database 16 (S340). The amount of insurance to be paid is calculated, and the insurance is paid to the user (S350). Finally, the user database 12, the member store database 14, and the objected merchandise database 18 are updated (S360).

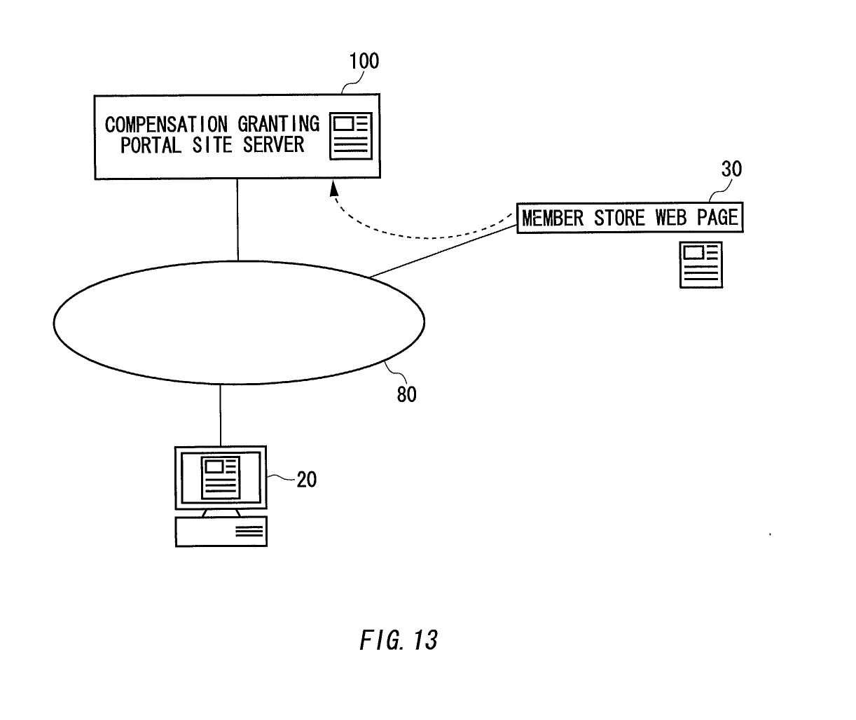

FIG. 13 shows a system including a portal site server 100 of a second embodiment of the present invention. The portal site server 100 is connected to the Internet 80. The portal site server 100 provides the compensation-granting portal site having a first URL that transmits the information related to the compensation through the Internet 80. The member store web page 30 provided by the member store can be accessed from the Internet 80. The member store is a member of this system. The user terminal 20 used by the user is connected to the Internet 80.

The portal site server 100 receives the member store web page 30 having a second URL when the user requests the member store web page 30 of the member store server in the portal site server 100. The portal site server 100 then rewrites the second URL of the member store web page 30 to be linked to the first URL of the compensation-granting portal site and transmits the rewritten second URL to the user terminal 20.

Furthermore, the portal site server 100 provides the compensation for a deal when a deal is performed on the member store web page 30, the second URL of which is rewritten. An insurance company, for example, can operate the insurance-providing portal site server 10. In this case, the compensation can be insurance.

The user gets access to the insurance-providing portal site server 10 when the user purchases merchandise. The user can request the web page of the other server by clicking a button indicated on the screen provided by the compensation-granting portal site. The user can read the web page requested by the user or perform a deal on the web page while the user stays inside the insurance-providing portal site server 10 without jumping to the web page requested by the user.

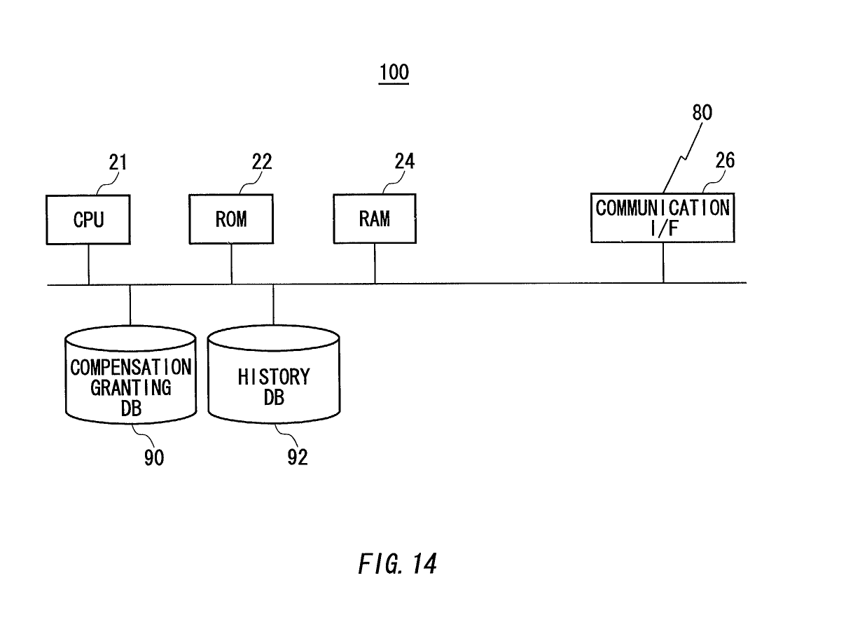

FIG. 14 shows a hardware configuration of the portal site server 100 of the second embodiment. The portal site server 100 has a CPU 21, a ROM 22, a RAM 24, a communication interface 26, a compensation-granting database 90 and a history database 92 inside a hard disk, which is not shown in the figure.

The portal site server 100 processes the compensation-granting database 90 and the history database 92 according to a program stored in the CPU 21, the ROM 22, and the RAM 24. Then, the portal site server 100 transmits the processed results to the Internet 80 through the communication interface 26.

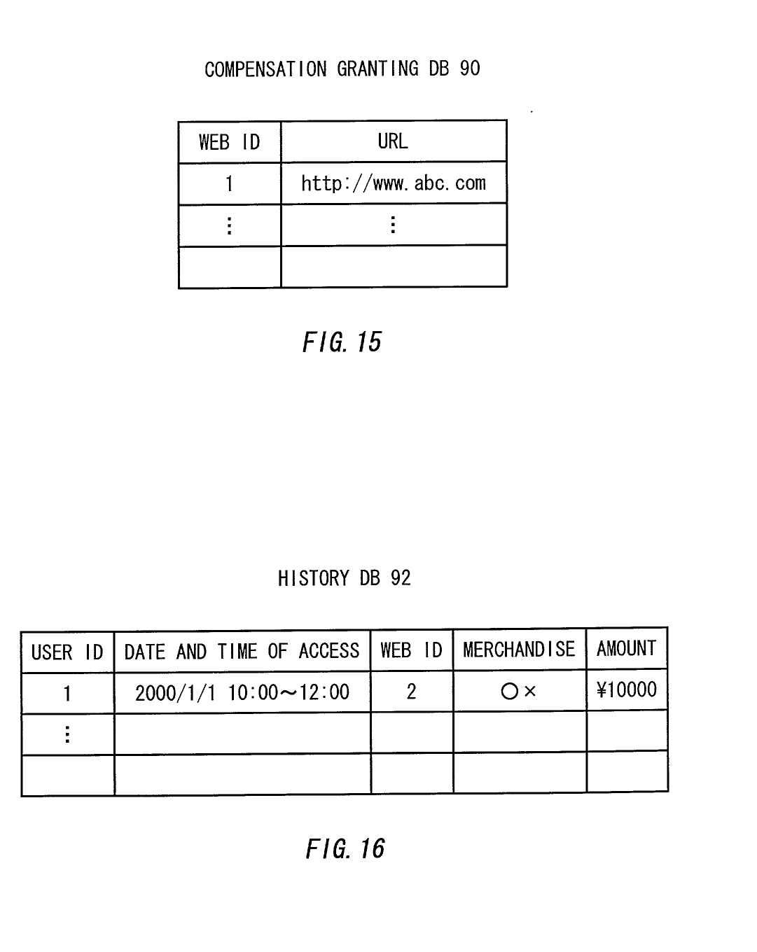

FIG. 15 shows an example of the compensation-granting database 90. The URL (identification information) of the web page, which can provide the compensation, such as insurance, is stored in the compensation-granting database 90 with the corresponding web ID that identifies the web page.

FIG. 16 shows an example of the history database 92. The access history of the user is stored in the history database 92 with the corresponding user ID (identification information) that identifies the user. More precisely, the access history includes information such as the date and the time of access by the user, the web ID of the accessed web page, and the deal information such as the purchased merchandise and the price of the merchandise.

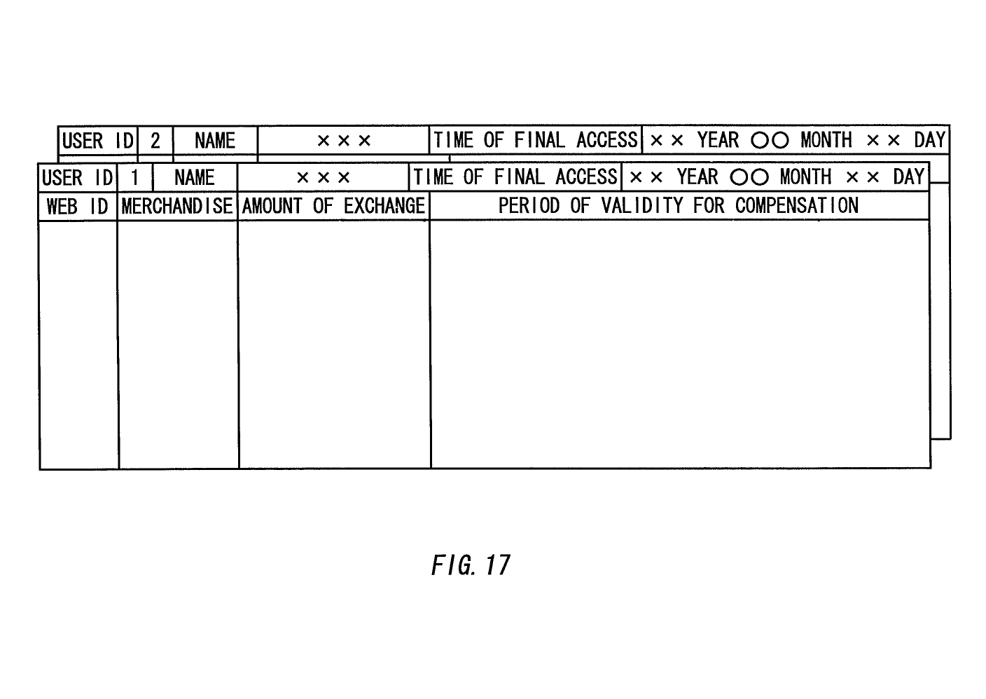

FIG. 17 shows another example of the history database 92. In the present embodiment, the history database 92 functions as the storing unit for storing data. The history database 92 has tables for every user. Each table has a user ID field, a name field, final access time field, and a deal history field. The deal history field further has a web ID field, a merchandise field, deal amount field, and a field for a period of validity for compensation. The final access time field stores the information that specifies the date and the time of when the user finally accessed the compensation granting portal site. The compensation validity period field stores the information that specifies the validity period of the compensation to be granted to the deal.

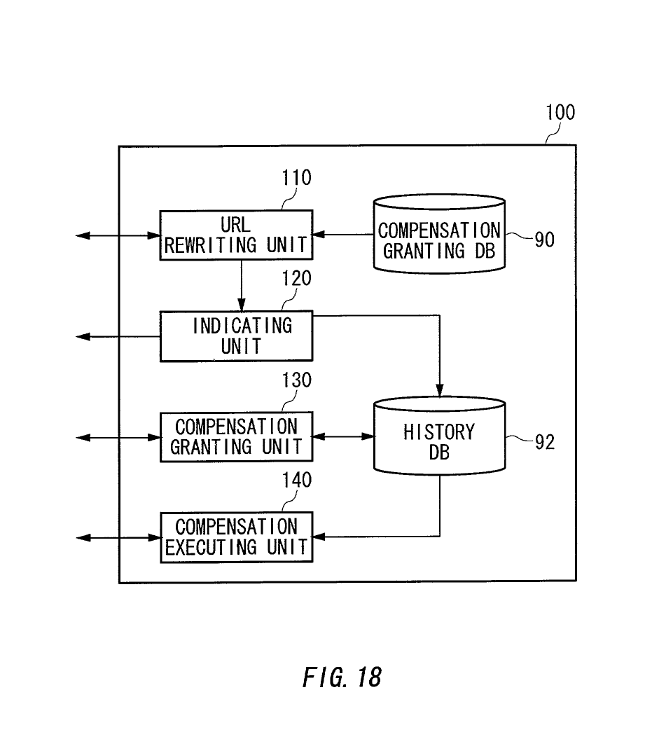

FIG. 18 shows a configuration of the portal site server 100. The portal site server 100 has the compensation-granting database 90 and the history database 92. The portal site server 100 further has a rewriting unit 110, an indicating unit 120, a compensation-granting unit 130, and a compensation-executing unit 140 as a function unit.

When the user terminal 20 requests the member store web page 30 of the other server, the URL rewriting unit 110 verifies whether compensation can be granted to the web page requested by the user using the compensation-granting database 90. The URL rewriting unit 110 then receives the member store web page 30 when the web page requested by the user is stored in the compensation-granting database 90.

The URL rewriting unit 110 rewrites the second URL of the member store web page 30 to be linked to the first URL of the compensation-granting portal site. The URL rewriting means 110 then transmits the rewritten second URL to the user terminal 20. Furthermore, the URL rewriting unit 110 outputs to the indicating unit 120 the information that the rewriting process has performed. The rewriting means 110 also outputs the information that specifies the user terminal 20 to the indicating unit 120.

A button that indicates the member store web page is provided on the compensation-granting portal site. The link information for each of the member store web pages can be obtained by clicking the corresponding buttons. The link information includes the information, which shows the URL of the compensation-granting portal site, the information that shows the CGI program stored in the portal site server 100, and the information that shows the member store web page, which is to be a parameter of the CGI program.

For example, the link information can be expressed as “ahref=http://www.ecanshin.com/dairi.cgi?http://www.□□□.co.jp”. Here, “www.ecanshin.com” is information that shows the first URL of the compensation granting portal site. The “dairi.cgi?” is information that shows the CGI program realized by the portal site server 100. “www.□□□.co.jp” is information that shows the second URL of the member store web page.

When the user clicks the button, the portal site server 100 receives the member store web page corresponding to the button clicked by the user. After the second URL of the received web page is rewritten by the URL rewriting unit 110, the rewritten second URL is sent to the user terminal 20.

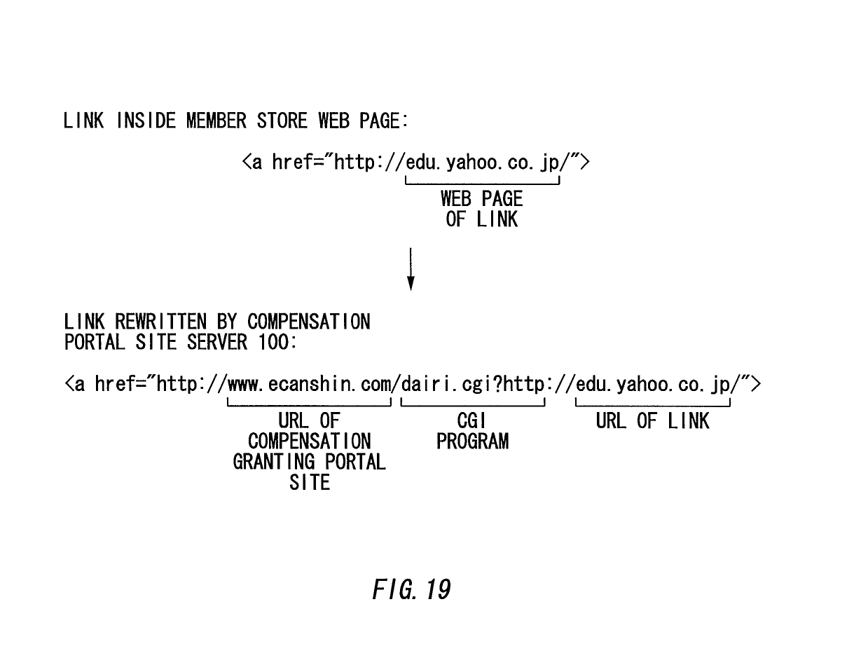

FIG. 19 shows an example of a process of rewriting the link information of the member store web page by the URL rewriting means 110. The URL rewriting unit 110 rewrites the link information of the received web page sequentially as a parameter of the CGI program. The CGI program is provided in the compensation-granting portal site. Thereby, the user can perform the deal using the screen and the program provided by the member store web page while staying in the portal site server 100.

Refer to FIG. 18 again, when the indicating unit 120 receives the specific information, the indicating unit 120 indicates on the user terminal 20 that compensation is granted to the deal performed on the web page, the second URL of which is rewritten. The specific information includes the information that the rewriting process has performed. The specific information also specifies the user terminal 20. Thereby, the user can recognize that compensation is granted to the deal.

When the compensation-granting unit 130 receives the deal information after the deal is performed on the member store web page 30, the second URL of which is rewritten, the compensation-granting unit 130 stores the deal information into the history database 92 with the corresponding user information. The deal information includes information that the deal is performed, the date and time of the deal, and the merchandise and the price of the deal. The compensation-granting unit 130 grants compensation for the deal based on this stored information. Here, if the history database 92 has the configuration shown in FIG. 17, the compensation-granting unit 130 may judge whether to grant the compensation to the deal based on the time of final access to the portal site server 100 by the user.

When the user applies for the compensation, the compensation-executing unit 140 verifies the deal information in the compensation request information using the history database 92. The time when the user applies for the compensation is the time when the compensation request information including the deal information is input from the user terminal 20. The compensation-executing unit 140 then judges whether the deal is truly performed using the history stored in the history database 92. The compensation-executing unit 140 pays the compensation to the user when the deal, for which the user applies for compensation, is stored in the history database 92. If the deal is stored in the history database 92, the deal is truly performed.

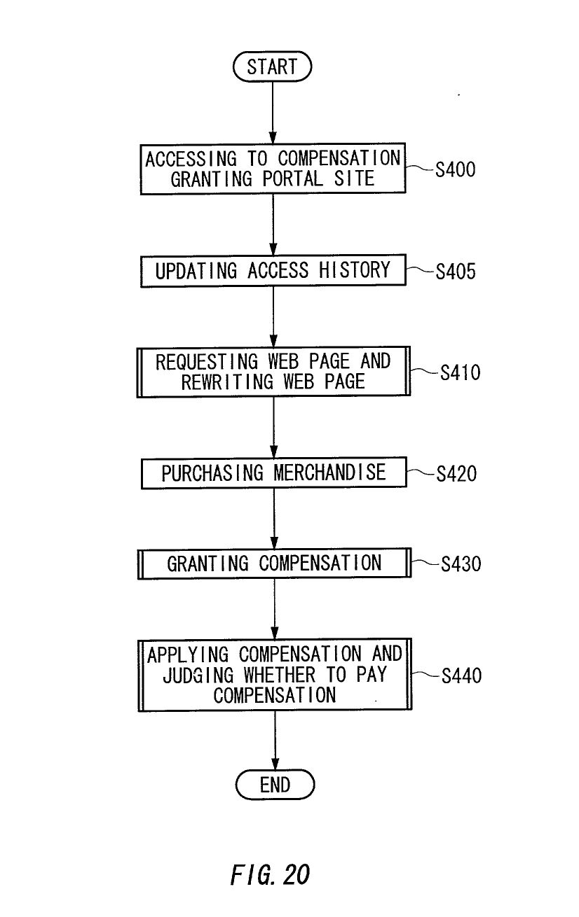

FIG. 20 shows a flow chart of applying for the compensation of a second embodiment. First, the user accesses the compensation-granting portal site (S400). The user then requests the web page by clicking a button provided on the compensation-granting portal site. The portal site server 100 rewrites the second URL of the requested web page using the URL rewriting unit 110 and indicates the rewritten second URL on the user terminal 20 (S410). The user then purchases the merchandise on the indicated web page (S420). The portal site server 100 grants the compensation to the merchandise purchased by the user (S430). Furthermore, the portal site server 100 judges whether to pay the compensation if the user applies for the compensation to the portal site server 100 (s440).

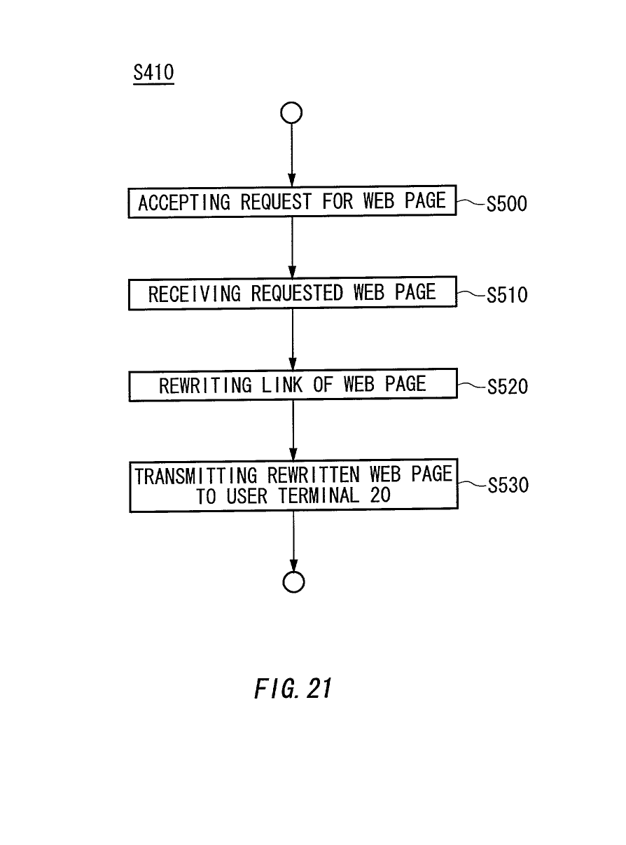

FIG. 21 shows a detail of an example of a process related to requesting the web page and rewriting the web page (S410). The URL rewriting unit 110 receives the request of the web page from the user (S500). The user requests the web page by clicking a button that shows the web page provided on the compensation-granting portal site. The above-described CGI program is related to this button.

The portal site server 100 receives the requested web page (S510) and rewrites the link information of the received web page sequentially as a parameter of the CGI program (S520). The portal site server 100 then transmits the web page, the link information of which is rewritten, to the user terminal 20 (S530).

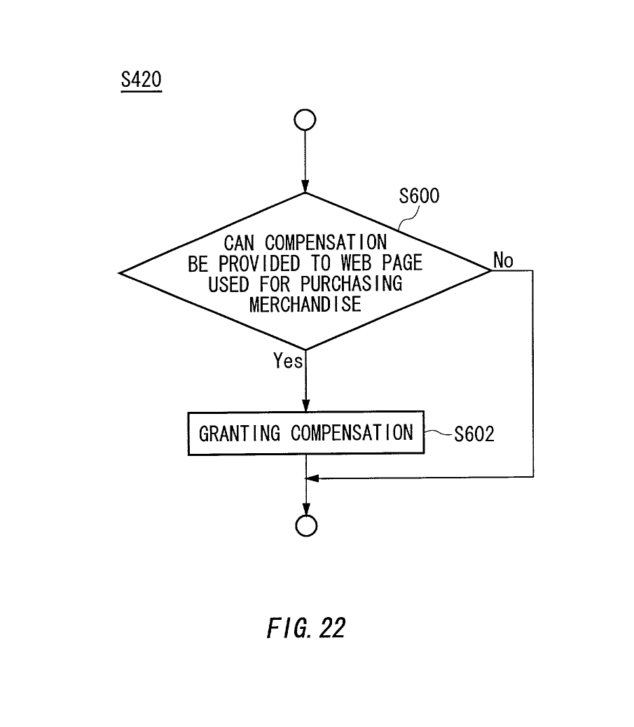

FIG. 22 shows an example of a process related to granting the compensation (S420). The portal site server 100 investigates whether the web page, at which the user purchases the merchandise, is a web page that can be granted the compensation using the compensation-granting database 90 (S600). If the web page, at which the merchandise is purchased, is not a web page that can be provided the compensation, the process related to grant of the compensation is finished. If the web page, at which the merchandise is purchased, is a web page that can be provided the compensation, the portal site server 100 grants the compensation to the purchase of the merchandise (S620).

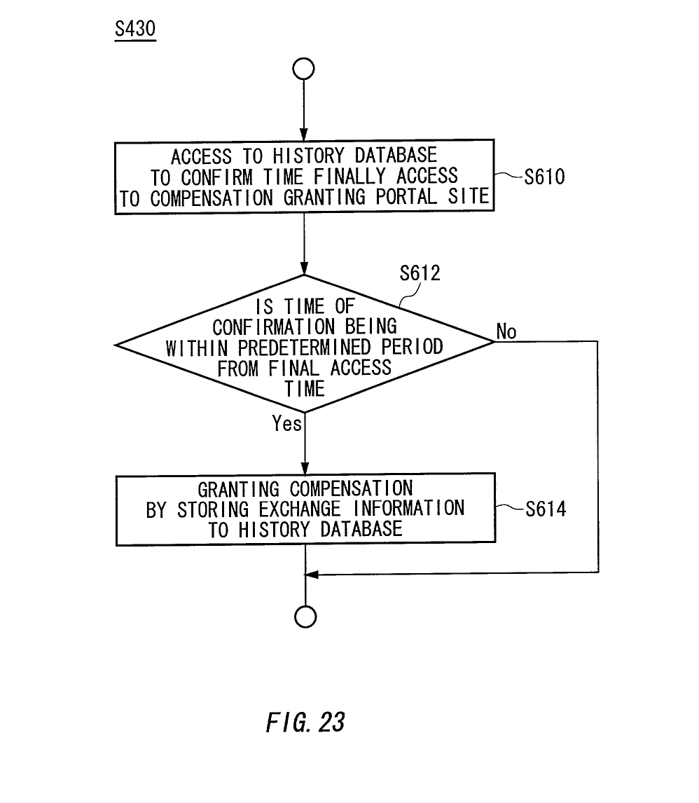

FIG. 23 shows another example of the process related to granting the compensation (S430). This example can be used when the history database 92 has the configuration shown in FIG. 17. The portal site server 100 accesses the history database 92 to confirm the time of final access to the portal site server 100 by the user (S610). The portal site server 100 grants the compensation to the deal (S614) by storing the deal information into the history database 92 only when the time of confirmation is within a predetermined period, for example within one hour, from the final access time (S612).

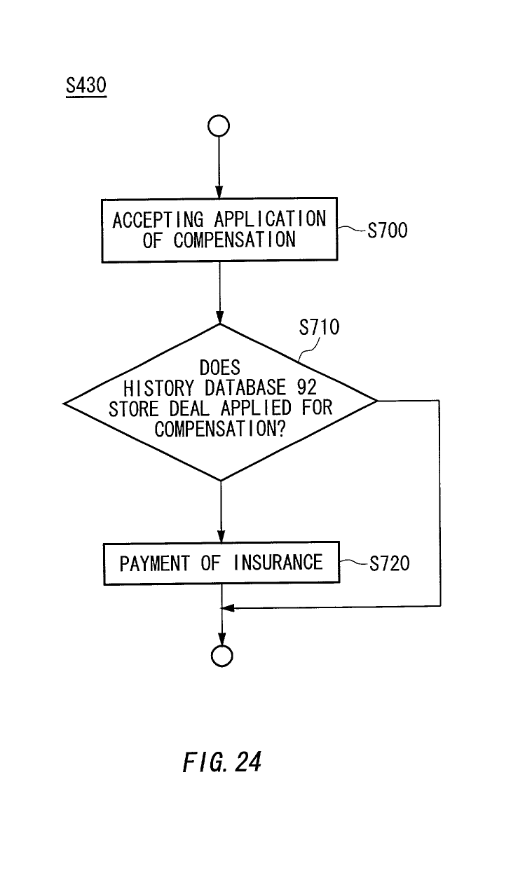

FIG. 24 shows a flow chart of a process related to application for the compensation and payment of the compensation (S430). The portal site server 100 receives the application for the compensation for the deal from the user (S700). The portal site server 100 judges whether the deal applied by the user for the compensation is stored in the history database 92 (S710).

If the deal applied for the compensation is not stored in the history database 92, the process related to the application for the compensation and payment of the compensation is finished. If the deal applied for the compensation is stored in the history database 92, the portal site server 100 processes the payment of the compensation applied for by the user (S720).

Although the present invention has been described by way of exemplary embodiments, it should be understood that those skilled in the art might make many changes and substitutions without departing from the spirit and the scope of the present invention, which is defined only by the appended claims.

What is claimed is:

1. A server for a compensation-granting portal site on the Internet having a first URL, the server comprising:
a URL rewriting unit for receiving a second URL of a web page of another server upon a user's request, for rewriting said second URL to be linked to said first URL, and for transmitting said rewritten second URL to the user.

2. A server as claimed in claim 1, further comprising a compensation-granting unit connected to said URL rewriting unit, said granting unit granting compensation relating to a deal performed by the user on said web page having said second URL.

3. A server as claimed in claim 2, wherein said compensation-granting unit grants said compensation by means of insurance.

4. A server as claimed in claim 1, further comprising:
a compensation-granting database for storing identification information that identifies said web page having said second URL which provides the deal, to which said compensation can be granted; wherein:
said URL rewriting unit rewrites said second URL when identification information of said web page requested by the user is stored in said compensation-granting database.

5. A server as claimed in claim 1, further comprising:
a compensation-granting database for storing identification information that identifies said web page having said second URL which provides the deal, to which said compensation can be granted; wherein:
said compensation-granting database grants compensation for said deal when identification information of said web page, on which the deal is performed, is stored in said compensation-granting database.

6. A server as claimed in claim 1, further comprising:
a compensation-granting database for storing identification information that identifies said web page having said second URL which provides the deal, to which said compensation can be granted; and
an indicating unit for indicating on a terminal of the user that said compensation is granted to said deal performed on said web page when identification information of a web page requested by the user is stored in said compensation-granting database.

7. A server as claimed in claim 1, further comprising:
a history database for storing an access history of the user accessing a web page having said first URL with corresponding identification information of the user; and
a compensation-executing unit for judging whether said deal is truly performed, when the user applies for compensation for said deal, using said access history stored in said history database, and for paying said compensation to the user when said deal is truly performed.

8. A server as claimed in claim 1, further comprising:
a history database for storing an access history of the user accessing a web page having said first URL with corresponding identification information of the user; and
said compensation-granting unit judges whether to grant said compensation to the user, based on a time of final access to said first URL, using said access history.

9. A server as claimed in claim 1, further comprising:
a storing unit for storing information that specifies a time of final access to the web page having said first URL by the user; and
said compensation-granting unit judges whether to grant said compensation to the user based on said time of final access stored in said storing unit.

10. A compensation-granting system provided on the Internet, comprising: a portal site server having a first URL and being connectable through the Internet with a user terminal through which a user requests a second URL; and
a URL rewriting unit for receiving said second URL of a web page of another server upon the user's request, and for rewriting said second URL to be linked to said first URL and for transmitting said rewritten second URL to the user.

11. A compensation-granting system as claimed in claim 10, further comprising a compensation-granting unit connected to said URL rewriting unit, said granting unit granting compensation relating to a deal performed by the user on said web page having said second URL.

12. A method for granting compensation for a deal performed on the Internet for use with a portal site server having a first URL, comprising the steps of:
receiving a second URL of a web page of another server upon a user's request; and
rewriting said second URL to be linked to said first URL of said portal site server which grants compensation for the deal; and
transmitting said rewritten second URL to the user.

13. A method as claimed in claim 12, further comprising the steps of: granting compensation for a deal that is performed by the user on said web page having said second URL.

14. A method as claimed in claim 12, wherein: said step of granting compensation grants said compensation by means of insurance.

15. A method as claimed in claim 12, further comprising the step of:
storing identification information that identifies a web page having said second URL which provides the deal, to which said compensation can be provided; wherein:
said step of rewriting said second URL rewrites said second URL when identification information of a web page requested by the user is stored by said storing step.

16. A method as claimed in claim 12, further comprising the step of:
storing identification information that identifies a web page which provides a deal, to which said compensation can be provided; wherein:
said step of granting said compensation grants compensation to said deal when identification information of a web page, on which the deal is performed, is stored by said storing.

17. A method as claimed in claim 12, further comprising the steps of:
storing identification information that identifies a web page which provides a deal, to which said compensation can be provided; and
indicating on a terminal of the user that said compensation is granted to the deal performed on said web page when said identification information of said web page requested by the user is stored by said storing.

18. A method as claimed in claim 12, further comprising the steps of:
storing an access history of the user accessing said portal site server with corresponding identification information of the user; and
judging whether the deal is truly performed based on said access history stored by said storing step when the user applies for compensation for said deal; and
paying said compensation to the user when said deal is truly performed.

19. A method as claimed in claim 12, further comprising the steps of:
storing an access history of the user accessing said portal site server with corresponding identification information of the user; and
judging whether to grant said compensation to the user, based on a time of final access to said portal site server, using said access history.

20. A method as claimed in claim 12, further comprising the steps of:
storing information that specifies a time of final access to said portal site server by the user; and
judging whether to grant compensation to the user, based on the time of final access to said portal site server, using said stored information.

21. A method for granting compensation for a deal performed on the Internet, comprising the steps of:
receiving access of a user who performs a deal at a web page linked to a portal site server that grants compensation; and
granting a compensation for the deal performed by the user.

22. A method as claimed in claim 21, wherein: said step of granting said compensation grants said compensation by means of insurance.

23. A method as claimed in claim 22, further comprising the step of:
storing a total amount of sales of merchandise sold at said web page and a total amount of said insurance paid to the user for said merchandise, with corresponding merchandise identification information that identifies said merchandise; and
setting or updating an amount of said insurance for said merchandise according to a ratio of said total amount of said insurance to said total amount of sales.

24. A method as claimed in claim 22, further comprising the steps of:
storing a total amount of sales of merchandise sold at web pages operated by member stores and a number of times of granting said insurance to said merchandise sold by each member store with corresponding member store identification information that identifies said member store; and
setting or updating a premium paid by said member store according to a ratio of said number of times of granting said insurance to said total amount of sales.

25. A method as claimed in claim 24, wherein said step of setting or updating sets or updates an amount of compensation that can be paid to the user according to said ratio of said number of times of granting said insurance to said total amount of sales.

26. A method as claimed in claim 22, further comprising the steps of:
storing a total amount of sales of merchandise sold at web pages operated by member stores and an amount of said insurance paid to the user for said merchandise sold by said member stores with corresponding member store identification information that identifies each member store; and
setting or updating a premium paid by said member store according to a ratio of said amount of said insurance paid to the user to said total amount of sales.

27. A method as claimed in claim 26, wherein said step of setting or updating sets or updates an amount of compensation that can be paid to the user according to said ratio of said amount of insurance paid to the user to said total amount of sales.

28. A method as claimed in claim 22, further comprising the steps of:
storing a total amount of purchase of the user at said web page and a number of times of applying for said insurance by the user with corresponding user identification information that identifies the user; and
setting or updating an amount of compensation paid to the user according to a ratio of said number of times of applying for said insurance by the user to said total amount of purchase of the user.

29. A method as claimed in claim 28, wherein said step of setting or updating sets or updates said amount of compensation that can be paid to the user according to said ratio of said number of times of applying for said insurance by the user to said total amount of purchase of the user.

30. A method as claimed in claim 22 further comprising the steps of:
storing a total amount of purchase of the user at said web page and an amount of compensation paid to the user with corresponding user identification information that identifies the user; and
setting or updating an amount of compensation paid to the user according to a ratio of said amount of compensation paid to the user to said total amount of purchase of the user.

31. A method as claimed in claim 30, wherein said step of setting or updating sets or updates said amount of compensation that can be paid to the user according to said ratio of said amount of compensation paid to the user to said total amount of purchase of the user.

32. A method as claimed in claim 23 or 24, wherein said step of setting or updating sets or updates coverage applied to said merchandise according to said ratio of said total amount paid as insurance for said merchandise to said total amount of sales for said merchandise.

33. A method as claimed in claim 28, wherein said step of setting or updating sets or updates a limit for the user to purchase merchandise, to which said compensation can be paid, according to said ratio of said number of times of applying for said insurance by the user to said total amount of purchase.

34. A method as claimed in claim 30, wherein said step of setting or updating sets or updates a limit for the user to purchase merchandise, to which said compensation can be paid, according to said ratio of said amount of compensation paid to the user to said total amount of purchase of the user.

35. A method as claimed in claim 21, further comprising the steps of:
storing a number of times of access to said portal site server by the user; and
judging whether to provide said compensation to the user based on said number of times of access.

36. A server for a insurance-granting portal site on the Internet having a first URL, the server comprising:
a URL rewriting unit for receiving a second URL of a web page of another server upon a user's request, for rewriting said second URL to be linked to said first URL, and for transmitting said rewritten second URL to the user;
a compensation-granting unit connected to said URL rewriting unit, said granting unit granting insurance relating to a deal performed by the user on said web page having said second URL; and
a compensation-granting database for storing identification information that identifies said web page having said second URL which provides the deal, to which said compensation can be granted; wherein:
said URL rewriting unit rewrites said second URL when identification information of said web page requested by the user is stored in said compensation-granting database; and
said compensation-granting database grants compensation for said deal when identification information of said web page, on which the deal is performed, is stored in said compensation-granting database.
